(19) United States
(12) Patent Application Publication
(10) Pub. No.: US 2011/0288932 A1
(43) Pub. Date: Nov. 24, 2011

(54) APPARATUSES, SYSTEMS AND METHODS FOR DETERMINING INSTALLED SOFTWARE APPLICATIONS ON A COMPUTING DEVICE

(75) Inventors: Edward Marks, Palo Alto, CA (US); James Anthony, Palo Alto, CA (US)

(73) Assignee: Inedible Software, LLC, a Wyoming Limited Liability Company, Palo Alto, CA (US)

(21) Appl. No.: 13/112,994

(22) Filed: May 20, 2011

Related U.S. Application Data
(60) Provisional application No. 61/347,308, filed on May 21, 2010.

(51) Int. Cl. G06F 17/30; G06Q 30/00

(52) U.S. Cl. 705/14.49; 707/769; 705/14.4; 707/E17.014

(57) ABSTRACT

Apparatuses, systems and methods are disclosed which provide for determining identification of software installed on a device using one or more of information about the file system structure, and operation wherein the step of determining the identification of software is performed real-time. The apparatuses, systems and methods can be used to identify applications regardless of any security or obfuscation processes employed by the device.

### CROSS-REFERENCE

This application claims the benefit of U.S. provisional patent application 61/347,308 entitled “Method for Determining Installed Software Applications on a Personal Computing Device” filed May 21, 2010, the contents of which are incorporated herein.

### BACKGROUND OF THE INVENTION

This disclosure relates generally to systems and methods for identifying installed software on a personal computing device and more particularly to a method for identifying installed software on the device without any user intervention and without any compliance from the installed software being detected. The identification can be performed on a real-time or near real-time basis.

There recently has been a trend toward the wide scale development of software applications for various types of personal computing devices and mobile devices, such as smart phones and PDA's that are Internet and multi-media enabled devices (e.g., Apple's iPhone, iPad, and iPod Touch, Google's Android™ and RIM's BlackBerry®). Users of such mobile devices are able to select desired software applications to download and install onto their mobile devices. These downloadable software applications (“apps”) are often developed by third parties not affiliated with the device manufacturer. In some situations, it can useful to have an understanding of what software applications have been installed on certain mobile devices. It is currently estimated that there are over 120,000 active apps for the mobile market (with over 300,000 inactive applications) and more than 40,000 unique app publishers (see 148apps.biz).

In order to protect the integrity of the device and prevent corruption of device operation that might occur from use of an app, many modern computing systems, particularly mobile devices such as the iPhone, provide security measures that provide tightly controlled resources for such third party applications. The security process, a “sandbox,” limits knowledge and access to the device's contents by the application. In this manner, a software application that has been downloaded and installed will not typically be able to ascertain the presence of other software applications on the same device. As such, this can make it difficult or impossible to reliably identify other software installed on a mobile device, particularly at runtime.

Attempts have been made to identify software installed on a mobile device. In one previous approach, as shown in FIG. 1, a software application 138 installed on a device 100 may “phone home” to a remote server with its own identity and the identity of the device (e.g., the international mobile equipment identification (“IMEI”) number) on which the software has been installed. Over time, a database 190 is constructed on a remote server with mappings of devices (e.g., identified by IMEI number) to installed applications. The database 190 is accessible by a device through the Internet 150.

Disadvantages associates with this approach are that: 1) each participating application must cooperate in order to facilitate data collection, 2) additional server calls must be made, 3) additional code must be included in each participating software application, 4) authors of the software applications must have the foresight to include the code well before the information is needed, 5) the participating software applications need to be launched and able to report back to the server before they are successfully registered, 6) the server is never informed when an application is deleted from a device (so that an accurate list of installed software is not maintained), shown in FIG. 1 with the removal of App 4, which still appears in the database 190 as an App associated with the device, 7) servers and databases must be created and maintained, and 8) each participating software application has to register with a separate server/database for every different intended use of the information.

An example implementation of this prior approach is one performed by AdMob (www.admob.com) and other advertising networks that use this method to allow conversion tracking of advertising campaigns (applications report back to their server when they are launched so that AdMob can calculate how many users that clicked an advertisement for that app eventually purchase it). AdMob or the advertising network can then use this database to target future advertisements. Further, Flurry (www.flurry.com) and other analytics companies entice software developers to insert code to phone home by providing user usage and demographic data, then can use the database they built to target advertising. See, for example, U.S. Patent Pubs. US 2008/0059285 A1 to Hamoui for Assessing a Fee for an Ad, US 2008/0059299 A1 to Mahoui for Delivering Ads to Mobile Devices (and WO 2008/030358 A2/A3), US 2010/0100445 A1 to Flood et al. for System and Method for Targeting the Delivery of Inventoried Content Over Mobile Networks to Uniquely Identify Users; and PCT Publication WO 2010/098890 A1 to Sivaramakrishnan for Systems and Methods for Sending Content to a Website on a Network of Websites.

Another approach for identifying software installed on a device has been for a software application to intentionally leave a telltale sign of its existence, for other applications to later detect. One approach to leaving a telltale sign of its existence is for a file to be put into a globally accessible location (such as a pasteboard). Disadvantages of this approach are 1) each participating software application must cooperate, 2) additional code must be included in each participating software application to perform this function, 3) authors of the software applications must have the foresight to include the code well before the information is needed, 4) the participating applications need to be launched before they can be detected, and 5) software applications cannot report their own deletion (again, so that an accurate list of installed software is not maintained).

There is also an existing method by which the system can be asked whether or not any apps exist which can open a certain URL scheme. For example, Facebook's app has the format fb://<parameters> whereas Shotgun may respond to shotgun://<parameters>. Often these URL schemes are in place for unrelated reasons, but can be exploited to determine the presence of an installed app. There are still disadvantages to this method, including 1) not all applications have a custom URL scheme, and 2) any app may respond to whatever scheme they want to, so the data is very inaccurate (there's no regulation of what schemes are accepted, so any number of apps can share the same schemes).

Yet another approach for identifying software installed on a device has been for operating systems for the devices to be designed so they are generally not restrained by its own security measures, so that the operating system is able to see what applications are installed directly on the device. A disadvantage with this approach is that it is not possible for third party software application developers to have any control over the design of the operating systems of the corresponding devices on which the software applications are to be installed. One implementation of this approach is Apple's use of knowledge of installed applications on a user's device to recommend other software with its “Genius” feature.

Still a further approach for identifying software installed on a device has been for sellers of software applications (either the retailer or developer directly) to maintain records of their sales. Disadvantages of this approach are 1) sales records may not be able to be matched if they are not tied to a specific user account, 2) sellers are not notified when a software application is deleted so their information becomes outdated, 3) different sellers would need to cooperate in order to develop a full list of software applications for a specific device. One implementation of this approach is that Apple also makes recommendations to users of software to purchase based on their previous purchase history.

Another approach for identifying software installed on a device may be for the user to be asked what specific software they have installed on their device. The disadvantages with this approach are that 1) it is tedious for the user to respond, 2) users cannot be expected to provide a complete list, and 3) there is no verification of accuracy of the user's actions. Implementations of this approach have been developed by some iPhone Apps that ask the user what applications they have for the purpose of either generating recommendations or sharing the list with friends or on social networks.

Still further, another approach for identifying software installed on a device includes asking a user whether they have a few specific software applications installed on their device in order to extrapolate a general profile of the user. Disadvantages include 1) no verification of the accuracy of the user's responses, 2) this approach does not determine whether a specific application is installed, 3) it is tedious for the user to cooperate, and 4) there may be imprecise results. Implementations of this approach have been embodied in some iPhone Apps that use this method to generate recommendations. This is also similar to the Netflix model for recommending movies based on viewing history.

Other information useful for understanding the disclosure can be found in U.S. Pat. No. 7,194,424 B2 to Greer et al. for User Demographic Profile Driven Advertising Targeting; U.S. Pat. No. 5,948,061 to Merriman et al. for Method of Delivery, Targeting, and Measuring Advertising Over Networks, U.S. Pat. No. 5,636,346 to Saxe for Method and System for Selectively Targeting Advertisements and Programming, U.S. Pat. No. 5,991,735 to Gerace for Computer Program Apparatus for Determining Behavioral Profile of a Computer User, U.S. Pat. No. 6,628,314 B1 to Hoyle for Computer Interface Method and Apparatus with Targeted Advertising, and U.S. Pat. No. 6,771,290 B1 to Hoyle for Computer Interface Method and Apparatus with Portable Network Organization System and Targeted Advertising.

### SUMMARY OF THE INVENTION

An aspect of the disclosure is directed to a method comprising: determining identification of software installed on a device using one or more of information about the file system structure, and operation wherein the step of determining the identification of software is performed real-time. The method can further comprise one or more of: testing repeatedly against a known database of possible software applications to construct a user profile of installed software applications on the user's device, determining whether certain software is installed on the device without requiring the detected software to be complicit in the detection, determining whether certain software is installed on the device without requiring user intervention, and comprising utilizing the software installation determinations for advertising purposes or other installation metrics.

Yet another aspect of the disclosure is directed to a system comprising: a device; a device processor configured or configurable to obtain a list of directories from the device; attempt an operation on an installed software application bundle within a directory on the device; and determine if a software application is present on the device. In at least some instances, the list of directories is or has been obfuscated on the device. Additionally, the device processor is configured or configurable to develop a user profile from the list of directories obtained from the device. The installed software application can be a target software application. In some instances, the device processor attempts the operation on another software application bundle within another directory on the device. In some instances, the device processor is configured to develop a list of software applications on the device. Additionally, the device processor is further configured or configurable to: instruct the device in a first instruction if a target software application is installed; and instruct the device in a second instruction if a target software application is not installed. In some configurations, the first instruction is an instruction to deliver an advertisement and the second instruction is an instruction not to deliver an advertisement; in other configurations the first instruction is an instruction not to deliver an advertisement and the second instruction is an instruction to deliver an advertisement. Further, the device processor is further configured or configurable to receive an advertisement over a network. Additionally, the device processor is further configured or configurable to deliver the advertisement after determining if the software application is present. In some configurations, a targeting fee can be calculated and charged, such as by charging an advertiser after receiving and delivering an advertisement over a network.

Another aspect of the disclosure is directed to a device comprising: a housing; a user interface; a device processor configured or configurable to obtain a list of directories; attempt operation on an installed software application bundle within a directory; and identify if a software application is present on the device. In at least some instances, the list of directories is or has been obfuscated on the device. Additionally, the device processor is configured or configurable to develop a user profile from the list of directories obtained from the device. The installed software application can be a target software application. In some instances, the device processor attempts the operation on another software application bundle within another directory on the device. In some instances, the device processor is configured to develop a list of software applications on the device. Additionally, the device processor is further configured or configurable to: instruct the device in a first instruction if a target software application is installed; and instruct the device in a second instruction if a target software application is not installed. In some configurations, the first instruction is an instruction to deliver an advertisement and the second instruction is an instruction not to deliver an advertisement; in other configurations the first instruction is an instruction not to deliver an advertisement and the second instruction is an instruction to deliver an advertisement. Further, the device processor is further configured or configurable to receive an advertisement over a network. Additionally, the device processor is further configured or configurable to deliver the advertisement after determining if the software application is present. In some configurations, a targeting fee can be calculated and charged, such as by charging an advertiser after receiving and delivering an advertisement over a network.

Still another aspect of the disclosure is directed to a method comprising: obtaining a list of directories; attempting an operation on an installed software application bundle within a directory from the list of directories; and identifying a presence or absence of a software application on the device. In at least some configurations, the list of directories is a list of obfuscated directories. Additionally, the method can include the step of developing a user profile from the information obtained in directories. The installed software application is a target software application. Moreover, the step of attempting is repeated a plurality of times. Additionally, the method can comprise the step of developing a list of software applications on the device. In at least some configurations, the step of identifying further comprises the steps of: instructing the device in a first instruction if the step of identifying indicates a target software application is installed; and instructing the device in a second instruction different from the first if the step of identifying indicates a target software application is not installed. In some configurations, the first instruction is an instruction to deliver an advertisement and the second instruction is an instruction not to deliver an advertisement; in other configurations, the first instruction is an instruction not to deliver an advertisement and the second instruction is an instruction to deliver an advertisement. Additionally, the method can include the step of receiving an advertisement over a network and more specifically delivering an advertisement to the device. The step of delivering is performed after the step of identifying. In some configurations, a targeting fee can be calculated and charged. In other configurations, the targeting fee can be charged to an advertiser after receiving and delivering an advertisement over a network. Additionally, at least some configurations also include the step of determining whether more unexamined directories exist.

Yet another aspect of the disclosure is directed to a computer program product for delivering to a device, the computer program product being embodied in a computer readable storage medium and comprising computer instructions for: obtaining a list of directories; attempting an operation on an installed software application bundle within a directory from the list of directories; and identifying a presence or absence of a software application on the device. In at least some configurations, the list of directories is a list of obfuscated directories. In at least some other configurations, the step of developing a user profile from the information obtained in directories. the installed software application is, in at least some configurations, a target software application. Moreover, the step of attempting can be repeated a plurality of times. Additionally, in some configurations, the method further comprises the step of developing a list of software applications on the device. In yet other configurations, the step of identifying further comprises the steps of: instructing the device in a first instruction if the step of identifying indicates a target software application is installed; and instructing the device in a second instruction different from the first if the step of identifying indicates a target software application is not installed. The first instruction is an instruction to deliver an advertisement and the second instruction is an instruction not to deliver an advertisement; alternatively, the first instruction is an instruction not to deliver an advertisement and the second instruction is an instruction to deliver an advertisement. In some embodiments, the method provides the step of receiving an advertisement over a network. Delivering an advertisement can be delivered to the device. The step of delivering is performed after the step of identifying. A targeting fee can be calculated and charged in some embodiments. The targeting fee can be charged to an advertiser after receiving and delivering an advertisement over a network. Additionally, the step of determining whether more unexamined directories exist.

An additional aspect of the disclosure is directed to a method comprising: obtaining a list of directories at a first time; attempting at the first time an operation on an installed software application bundle within a directory from the list of directories; and identifying at the first time, a presence or absence of a software application on the device; providing a list of software applications with a unique device identification number identified at the first time; obtaining a list of directories at a second time different than the first time; attempting at the second time an operation on an installed software application bundle within a directory from the list of directories; and identifying at the second time, a presence or absence of a software application on the device; providing a list of software applications with a unique device identification number identified at the first time; and comparing the list of software applications identified at the first time with the list of software applications identified at the second time.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a diagram illustrating a representative example of a currently employed technique for identifying applications on a device;

FIGS. 2A-B are diagrams illustrating a representative example of a technique for identifying applications on a device;

FIG. 3 is a block diagram of an exemplary computing environment through which identification of currently installed applications can be achieved;

FIG. 4 is a block diagram showing the cooperation of exemplary components of a system suitable for use in a system where identification of installed applications is achieved;

FIG. 5 is a flow chart illustrating a technique for identifying applications currently installed on a device;

FIGS. 6A-B are flow charts illustrating a technique for delivering an advertisement based on an identification of application currently installed on a device;

FIGS. 7A-B are flow charts illustrating a technique for comparing directories on a device to a list of target list of predictive apps; and

FIG. 8 is a diagram illustrating a representative example of a technique for identifying applications on a device.

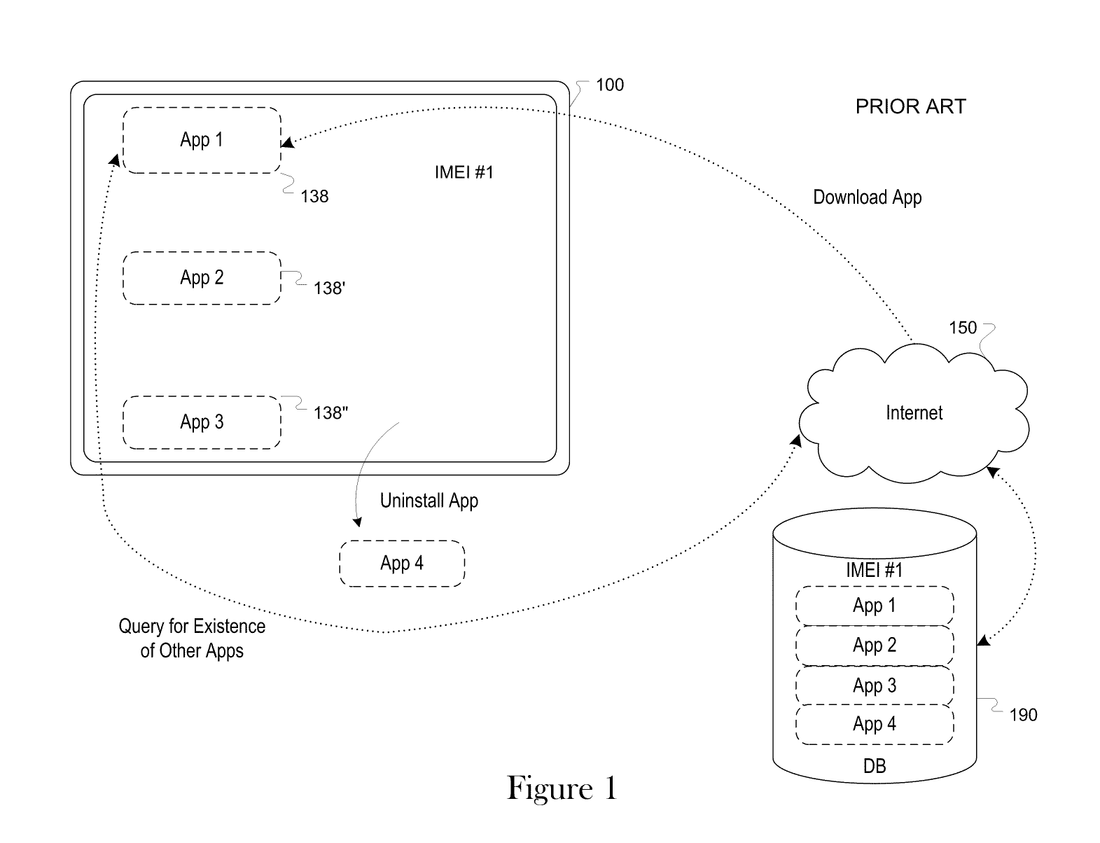

### DETAILED DESCRIPTION OF THE INVENTION

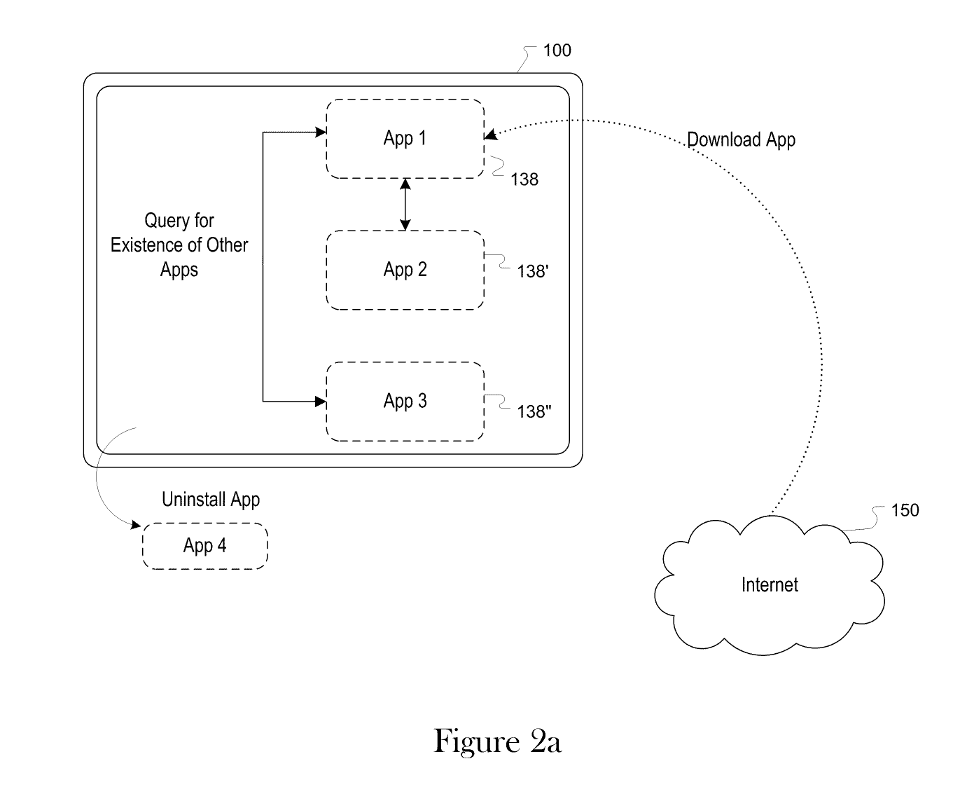

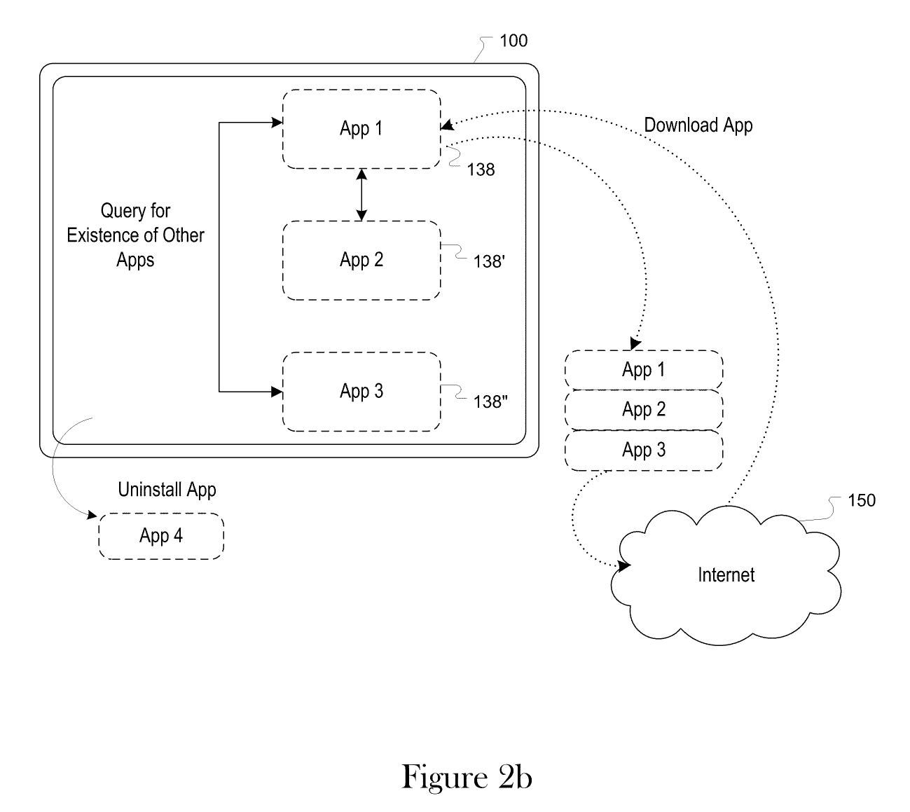

In one or more embodiments, apparatuses, systems and methods are provided for identifying whether other software, or targeted software, is installed on a computing device, such as a mobile computing device, even under security measures such as those in place on mobile computing devices (e.g., iPhone and the like). This software installation information is useful for a variety of applications including, but not limited to, analytics and advertising purposes. An overview of a system is illustrated in FIG. 2. A electronic device 100 is provided which has one or more software applications 138, 138′, 138″ operating on the device 100. The software applications 138 can be installed on the device prior to sale or can be downloaded onto the device, e.g., via the Internet 150.

### I. Computing Systems

The apparatuses, systems and methods described herein rely on a variety of computer systems, networks and/or digital devices for operation. In order to fully appreciate how the apparatuses, systems and methods operate an understanding of suitable electronic devices and computing systems is useful. The apparatuses, systems and methods disclosed herein are enabled as a result of application via a suitable electronic devices and computing system.

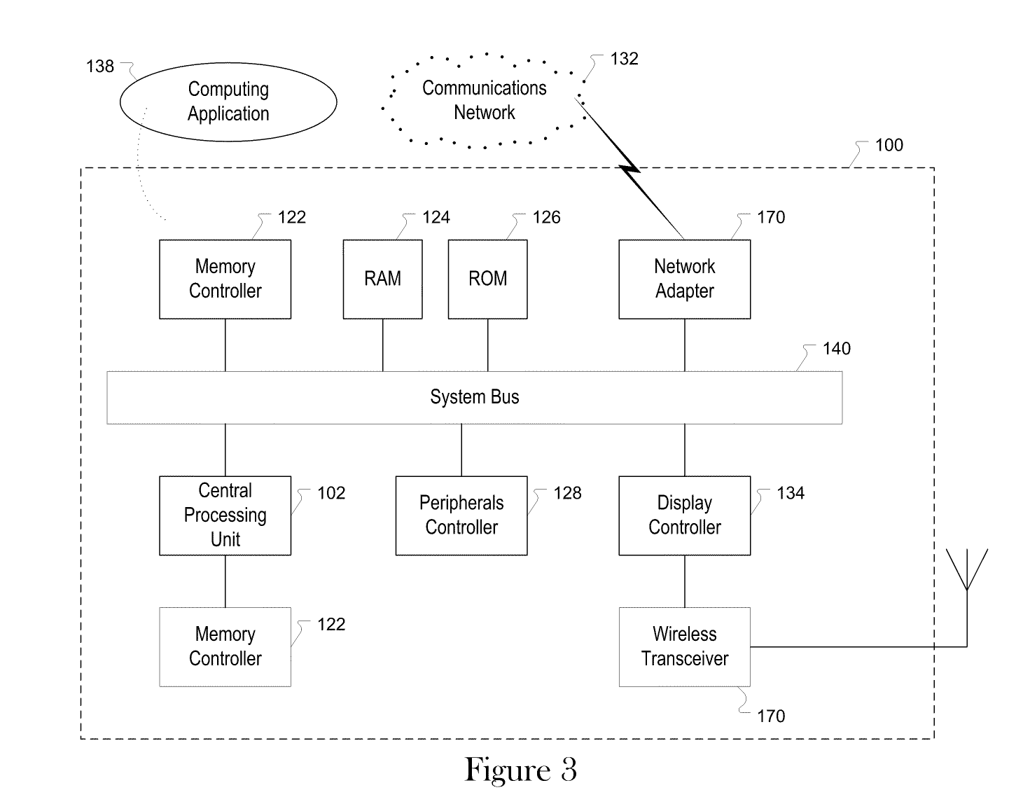

FIG. 3 depicts an exemplary computing system 100. The computing system 100 is capable of executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media adapted to tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132. The device 100 can also be configured to provide a wireless transceiver 170. The wireless transceiver in communication with one or more user stations. For example, the wireless transceiver 170 can include an antenna for radio or microwave frequency communication with the user stations. An access point through which the transceiver communicates can also be configured to provide a processor, a program memory, and a random access memory. Communications by devices through an access point can be subject to an authentication process, as would be appreciated by those skilled in the art.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components and user interfaces: a transceiver (for example a transmitter and a receiver, including a single chip transceiver with an integrated transmitter, receiver and, if desired, other functions); an antenna; a processor; a display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.), keypad. Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

The computer implemented system provides a storage and delivery base which allows users to exchange services and information openly on the Internet used to achieve the desired technical effect and transformation. A user will be enabled to operate as both a consumer and producer of any and all digital content or information through one or more master system servers.

A user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. Additionally, users can gain access to app stores (for obtaining apps for mobile devices) through the Internet or via an app downloaded onto the device.

### V. Computer Network Environment

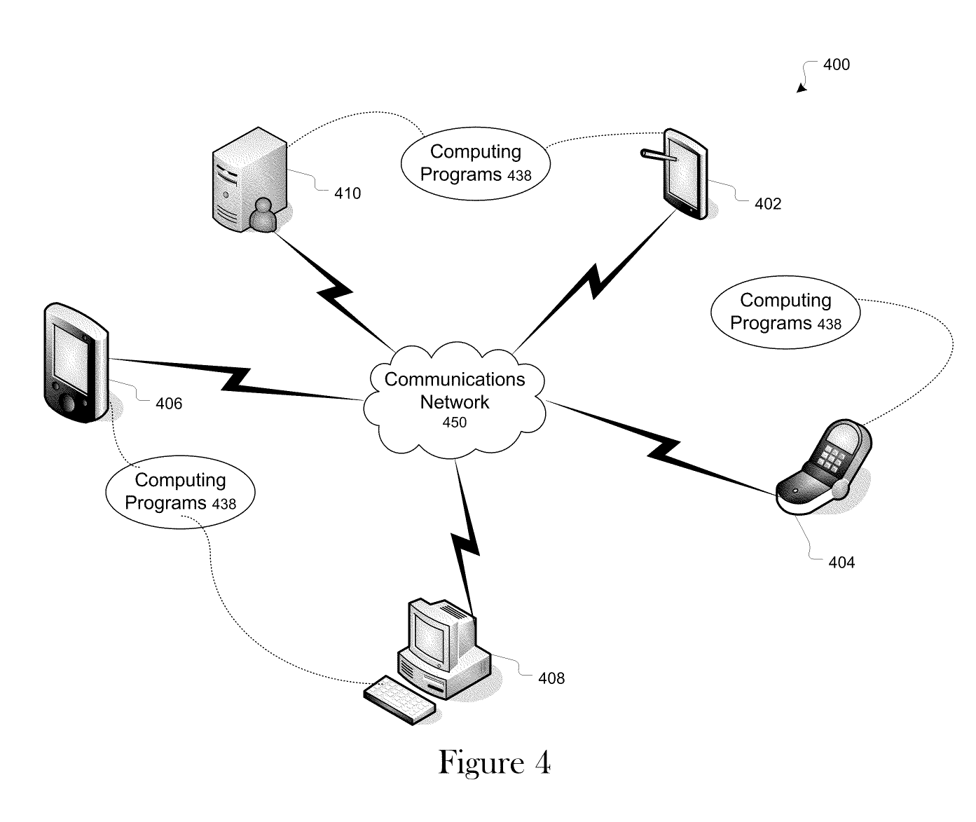

Computing system 100, described above, can be deployed as part of a computer network used to achieve the desired technical effect and transformation. In general, the above description for computing environments applies to both server computers and client computers deployed in a network environment. FIG. 4 illustrates an exemplary illustrative networked computing environment 400, with a server in communication with client computers or electronic devices via a communications network 450. As shown in FIG. 4, server 410 may be interconnected via a communications network 450 (which may be either of, or a combination of a fixed-wire or wireless LAN, WAN, intranet, extranet, peer-to-peer network, virtual private network, the Internet, or other communications network) with a number of client computing environments such as tablet personal computer 402, smart phone 404, personal computer 408, and personal digital assistant 406. In a network environment in which the communications network 450 is the Internet, for example, server 410 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 400 can utilize various data security protocols such as secured socket layer (SSL) or pretty good privacy (PGP). Each client computing environment can be equipped with operating system 438 operable to support one or more computing applications, such as a web browser (not shown), or other graphical user interface (not shown), or a mobile desktop environment (not shown) to gain access to server computing environment 400.

### VI. Media Independent Information Service

The Media Independent Information Service (MIIS) provides a framework and corresponding mechanisms by which an MIHF entity may discover and obtain network information existing within a geographical area to facilitate handovers. Additionally or alternatively, neighboring network information discovered and obtained by this framework and mechanisms can also be used in conjunction with user and network operator policies for optimum initial network selection and access (attachment), or network re-selection in idle mode.

MIIS primarily provides a set of information elements (IEs), the information structure and its representation, and a query/response type of mechanism for information transfer. The information can be present in some information server from which, e.g., an MIHF in the Mobile Node (MN) can access it.

Depending on the type of mobility, support for different types of information elements may be necessary for performing handovers. MIIS provides the capability for obtaining information about lower layers such as neighbor maps and other link layer parameters, as well as information about available higher layer services such as Internet connectivity.

MIIS provides a generic mechanism to allow a service provider and a mobile user to exchange information on different handover candidate access networks. The handover candidate information can include different access technologies such as IEEE 802 networks, 3GPP networks and 3GPP2 networks. The MIIS also allows this collective information to be accessed from any single network. For example, by using an IEEE 802.11 access network, it can be possible to get information not only about all other IEEE 802 based networks in a particular region but also about 3GPP and 3GPP2 networks. Similarly, using, e.g., a 3GPP2 interface, it can be possible to get access to information about all IEEE 802 and 3GPP networks in a given region. This capability allows the MN to use its currently active access network and inquire about other available access networks in a geographical region. Thus, a MN is freed from the burden of powering up each of its individual radios and establishing network connectivity for the purpose of retrieving heterogeneous network information. MIIS enables this functionality across all available access networks by providing a uniform way to retrieve heterogeneous network information in any geographical area.

### VII. Software Programs Implementable in the Computing and Network Environments to Achieve a Desired Technical Effect or Transformation

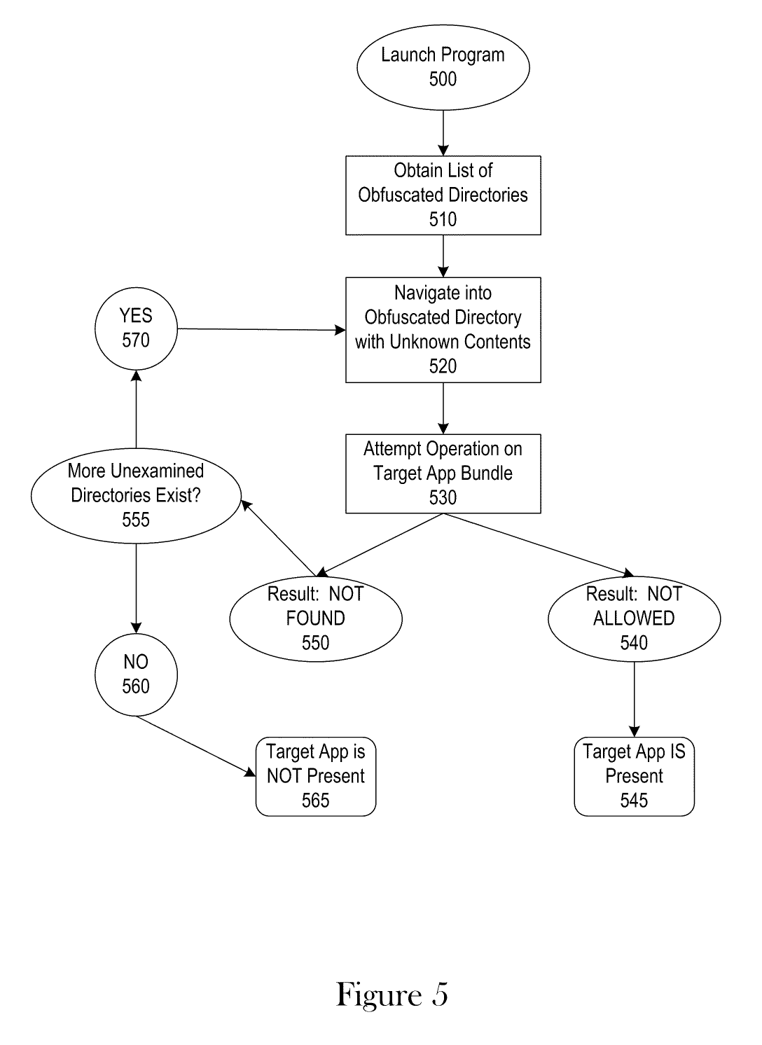

Turning now to FIG. 5, a user launches a program 500 from a device 100 interface. In the background, without further interaction from the user, a list of obfuscated directories 510 is obtained. Next, the obfuscated directories with unknown content are navigated into 520. An attempt is then made to operate on a target app bundle 530 as though the target app is present in that directory. If the result of the attempted operation is that the result is not allowed 540, then the target app is present 545. If the result of the attempted operation is that the result is not found 550, then a determination is made of whether more unexamined directories exist 555 and if there are none 560 then the target app is not present 565. If there are more unexamined directories 570 then those directories are navigated into 520 and the process is repeated until all the directories have been examined. As will be appreciated by those skilled in the art, the inquiry can be made to identify all other applications installed on a device or to identify specific applications of interest that may be installed on a device. As will be appreciated by those skilled in the art, performing an operation will have a different effect if the target application is located within the file folder than if the application is not present. Suitable operations include, but are not limited to, inspecting, moving, copying, navigating between, and modifying files or folders.

In one or more aspects of the disclosure, the apparatuses, systems and methods use information about file system structure on the device to determine whether a given software application is installed or not on the device. By testing repeatedly against a known database of possible applications, a complete user profile of installed software applications can be constructed. In some aspects of the disclosure, the apparatuses, systems and methods do not require that the other software (i.e., the installed software applications being detected) be complicit in the detection. Moreover, the apparatuses, systems and methods do not require user intervention.

As will be appreciated by those skilled in the art, an attempt to read the permissions of a file that would be present if the app were present, in some systems this call will fail, but the error will be of the nature “file not found” if the app is not present and “insufficient permissions” if it is. In another aspect, an attempt to read a file that would be present if the app were present, in some systems this call will fail, but the error will be of the nature “file not found” if the app is not present and “insufficient permissions” if it is. In yet another aspect, an attempt to navigate into a directory that would be present if the app were present, in some systems, even if one does not have sufficient permissions to check whether a directory exists, the navigation operation will still succeed if the folder is present, which then indicates the app is present. In still another aspect, an attempt to ask the file system if an executable file exists at the path where the executable for the application would be if it were present. In some systems, even if one does not have sufficient permissions to check whether a file exists at that path, the executable file operation will still succeed if the app is present. The systems disclosed can attempt one or more of the operations to determine whether or not an app is installed.

In one or more aspects of the disclosure, the apparatuses, systems and methods provided for determine and/or identify installed software on a device without any user intervention and without any compliance from the software application being detected. In one or more aspects of the disclosure, the computing device may be selected from, but are not limited to, the group comprising a mobile computer, a mobile device, a smart phone or the like (e.g., Apple iPhone, iPad, or iPod Touch, Google Android, BlackBerry, other PDA or smart phone or handheld computing device, etc.).

An accurate and up-to-date determination of installed software is obtainable by checking in real-time, or near real time, whether a software application is present without the need for access to any remote server or database at the time of the determination, rather than relying on a previously compiled database positioned on a remote server accessible via an Internet connection. The present apparatuses, systems and methods can provide a quick and efficient mechanism for determining either or installed software or whether a specific software application is installed.

In aspects of the disclosure, the apparatuses, systems and methods provide for software detection by using known or ascertainable information about the structure of the device's file system (such as the directory hierarchy, the method by which the presence of an application is normally obfuscated, etc.) and attempting operations on the file system (moving, copying, or deleting files, navigating into directories, etc.) whose result and/or side effects (success, failure, time taken, etc.) vary in a predictable way based on the presence of the application being investigated. The result and/or side effects may be analyzed to determine the presence of a software application.

As will be appreciated by those skilled in the art, the choice of the particular operations to attempt may be selected based on some knowledge of the software application whose presence is to be determined (e.g., its name, size, known contents, etc.). Once detected, this software installation information may be used for various analytics and advertising purposes.

Several uses are envisioned for the apparatuses, devices and methods configured or configurable to allow software detection as described herein. In one or more aspects of the disclosure, the detected software installation information may be utilized for advertising purposes. Advertising is commonly displayed in one mobile application to promote other mobile applications, either for the same software publisher or for a third party. By first checking whether or not the software application to be advertised is already installed on the device, the advertiser may use this information to affect advertising decisions, such as 1) choosing to avoid serving ads for an application already installed or 2) choosing to serve more targeted ads directly related to the installed application (e.g., other applications by the same software publisher, other software applications having related subject matter, etc.).

As discussed above, prior attempts to detect installation information and utilize such information for advertising purposes had many disadvantages. For example, AdMob's approach described above section is limited because it requires the application being advertised to have the forethought to include specific tracking code and also requires operations to call their servers. Further, Apple's prior approach described above does not provide for the possibility of other applications or advertisers to access their store data.

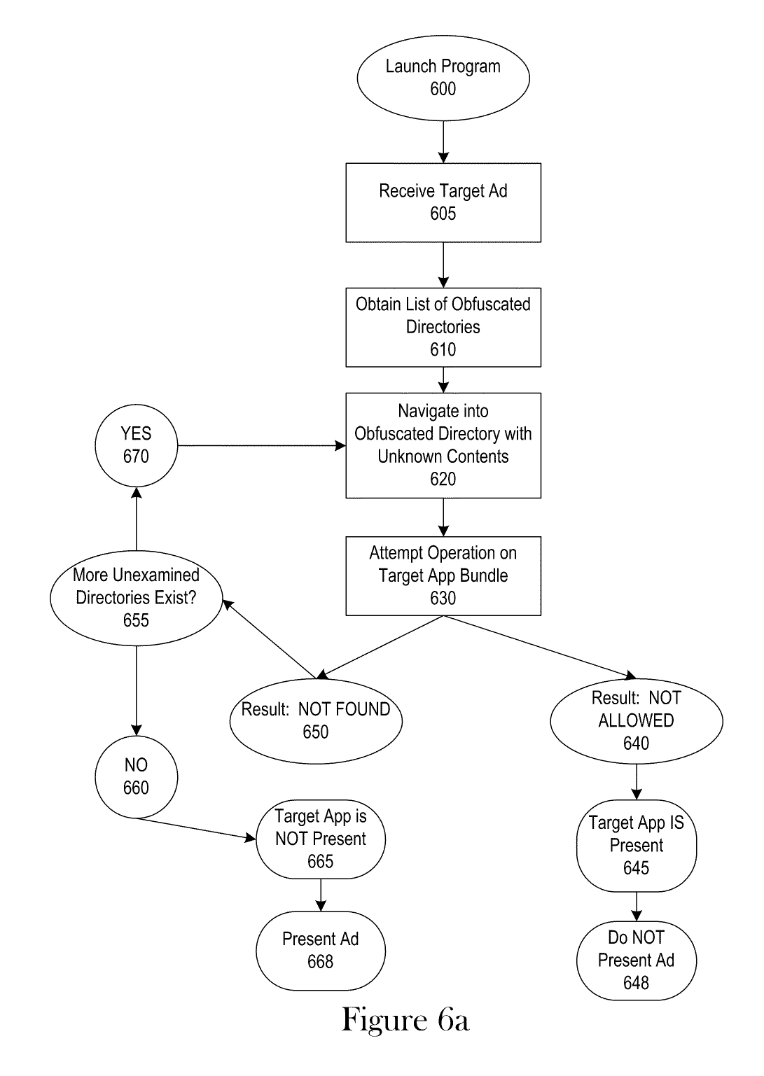

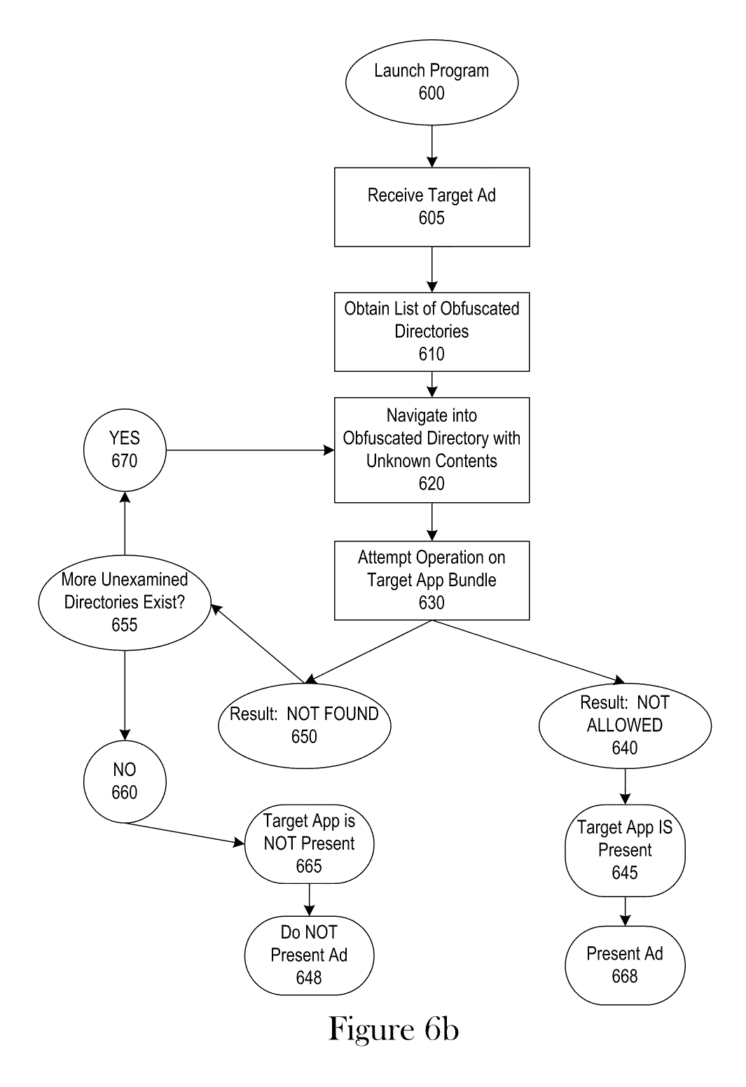

Turning now to FIGS. 6A-B a program 600 is launched, such as by a user from a device 100 interface. However, in some situations, a program may launch as part of an initiation of another program or process. In the background, without further interaction from the user, a target ad is received 605 for display to the user. a list of obfuscated directories 610 is obtained. Next, the obfuscated directories with unknown content are navigated into 620. An attempt is then made to operate on a target app bundle 630. If the result of the attempted operation is that the result is not allowed 640, then the target app is present 645, at which point a decision can be made to not present the Ad 648 as shown in FIG. 6A, or to present the Ad 668 as shown in FIG. 6B. The decision of whether or not to present the Ad in the presence of the target app will depend upon the objectives of the advertiser. For example, in one scenario, an advertiser may not want an Ad presented where, for example, the Ad is for an app that the user already has. In other scenario, the advertiser may want an Ad presented where, for example, the user has installed a competitive app.

If the result of the attempted operation is that the result is not found 650, then a determination is made of whether more unexamined directories exist 655 and if there are none 660 then the target app is not present 665, at which point a decision can be made to present the Ad 668 as shown in FIG. 6A, or to not present the Ad 648 as shown in FIG. 6B. As discussed above, the decision of whether or not to present the Ad in the presence of the target app will depend upon the objectives of the advertiser.

If there are more unexamined directories 670 then those directories are navigated into 620 and the process is repeated until all the directories, or all the target directories, have been examined. As will be appreciated by those skilled in the art, the inquiry can be made to identify all other applications installed on a device or to identify specific applications of interest that may be installed on a device.

In addition to avoiding serving ads to users who already have the promoted app installed, in one or more aspects of the disclosure the software detection methods described herein can be utilized by advertisers to provide accurate up-to-date information on the conversion rates of their software download campaigns, i.e. the percentage of users who actually download a software application after clicking on an advertisement for it. Prior methods of collecting this type of data suffered from the disadvantages and limitations described above in the Background section. Because many software download campaigns are now priced according to actual number of installs of a software application (often described as “Pay Per Install” as opposed to pay per click, etc.), advertisers using prior approaches may have the additional risk of losing income from developers who intentionally or unintentionally fail to properly report a successful install to the ad network's server.

The software detection methods of determining installed software applications described herein are enable an advertiser to start a campaign immediately, without needing a tracking code in the application prior to the campaign start, and the ad network can be more confident that they have accurate, up-to-date data regarding the number of actual installations of the software application in question.

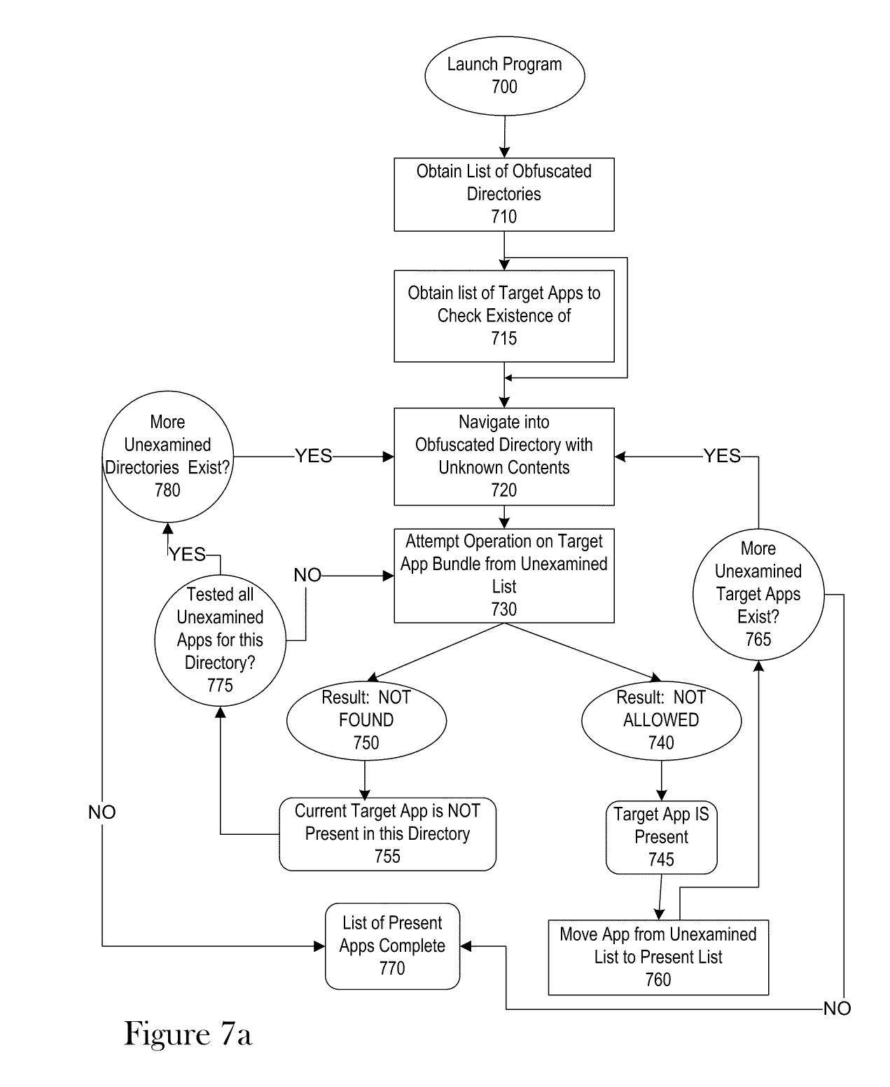

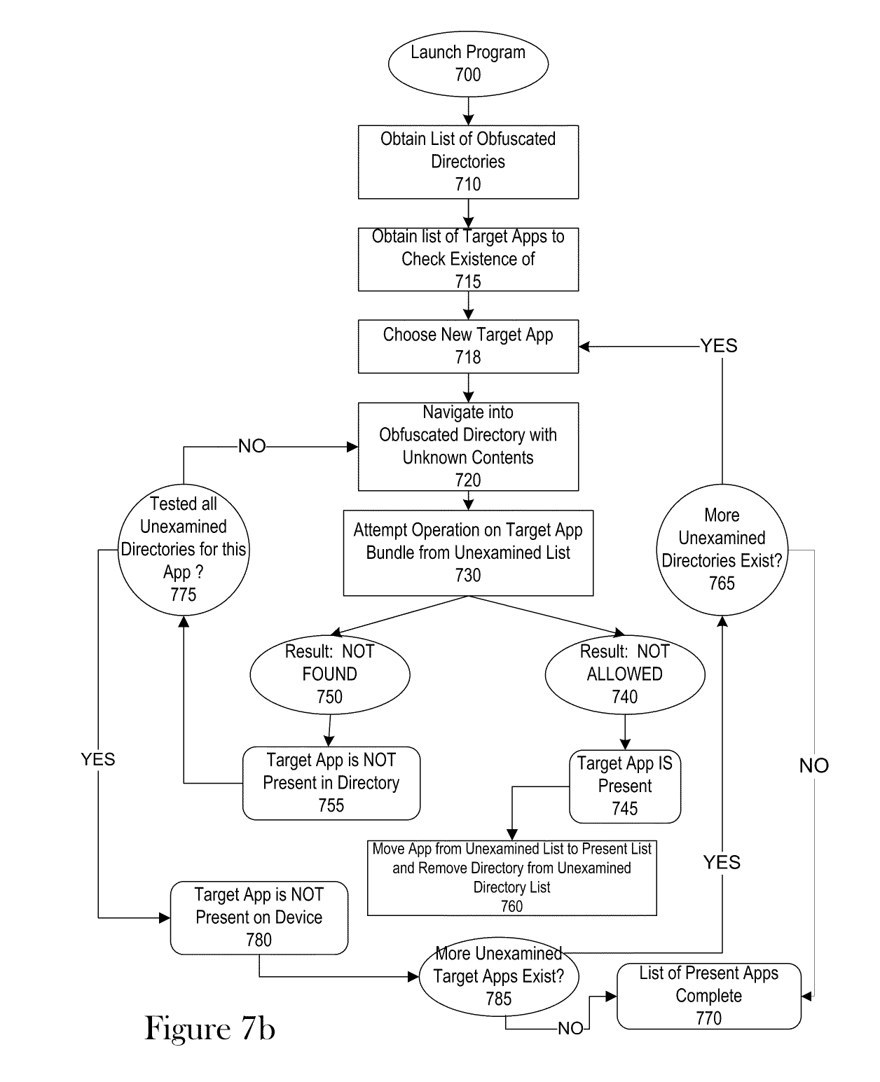

In another configuration, shown in FIG. 7A, a program 700 is launched, such as by a user from a device 100 interface. In the background, without further interaction from the user, a list of obfuscated directories 710 is obtained. A list of target apps to check the existence of is obtained 715. However, as will be appreciated by those skilled in the art, in at least some configurations this step can be skipped. Comparison to a target list of predictive apps enables a more focused review of installed apps, rather than an identification of all apps. Next, the obfuscated directories with unknown content are navigated into 720. An attempt is then made to operate on a target app bundle 730. If the result of the attempted operation is that the result is not allowed 740, then the target app is present 745. If the result of the attempted operation is that the result is not found 750, then a target app is not present 755.

Where the target app is present 745 the app from the target list is moved from an unexamined list to a “present” list 760. Thereafter, a check is made for more unexamined target apps 765. If there are no more unexamined target apps, then the list of present apps is complete 770.

Where the current target app is not present 755, thereafter a check is made to determine if all apps have been tested in the directory 775. If all the unexamined apps have not been tested, then an operation is attempted on a target app bundle 730, if all the apps have been tested, then a determination is made whether more unexamined target directories exist 780. If there are more unexamined target directories, then obfuscated directories with unknown content that have not previously been navigated into are navigated into 720 and the process repeats. If there are no more unexamined target directories, then the list of present apps is complete 770.

Turning to configuration, shown in FIG. 7B, a program 700 is launched, such as by a user from a device 100 interface. In the background, without further interaction from the user, a list of obfuscated directories 710 is obtained. A list of target apps to check the existence of is obtained 715. Thereafter a new target app can be selected 718. Next, the obfuscated directories with unknown content are navigated into 720. An attempt is then made to operate on a target app bundle 730. If the result of the attempted operation is that the result is not allowed 740, then the target app is present 745 and the app is moved from an unexamined list to a “present” list and the directory is removed from a list of unexamined directories 760. If the result of the attempted operation is that the result is not found 750, then a target app is not present 755.

Where the current target app is not present 755, thereafter a check is made to determine if all unexamined directories have been tested for the app 775. If not all unexamined directories have been checked, then the obfuscated directory with unknown contents is navigated into 720. If all the unexamined directors have been tested, then the target app is not present on the device 780. At that point, an assessment is made whether more unexamined target apps exist 785. If there are more unexamined apps, then an assessment is made of whether there are more unexamined directories 765. If there are more unexamined directories, a new target app is selected 718 and the process repeats. If more unexamined directories do not exist, then the list of present apps is complete 770.

While the above-described advertising uses focus on determining the presence of a single application on a device, in one or more aspects of the disclosure the present software detection methods can be used to determine a large number of installed software applications on a device (or devices) for purposes such as determining user habits and predictive modeling of user likes and dislikes.

One such demonstrated application is to recommend new software applications for a user to download. Previous attempts to provide such recommendations were hampered by requiring specific user feedback and involvement, where the user feedback could further not be verified for accuracy. Ad Networks may also use the present software detection methods for optimization by showing ads for applications which they predict a user is more likely to purchase.

In some aspects of the disclosure, the usefulness of the various aspects of the disclosure of the present software detection methods described herein are particularly useful when used in conjunction with devices in which the designer of the Operating System of the device also plays a role as Ad Network, such as Apple). Apple, Inc. stands out as a special case due to their dual nature as Ad Network and as Operating System architect. Because they control the iPhone platform as well as the iTunes App Store where applications are purchased, Apple is in a privileged position to have unfettered access to installed application data and to leverage it for ad serving optimization and application recommendation. In some aspects, the present software detection methods may be used by agents without such privileged position to be able to provide similar or better functionality by a more indirect but less restrictive means.

In one or more aspects of the disclosure, the present apparatuses, devices, and methods may further differentiate between different types or versions of a software application that share the same bundle name. In most cases there is only one application with a particular bundle name, such that the above-described method determines completely whether or not the user has that application installed. In some cases, this may not be true and different software applications may share the same bundle name (e.g., two software applications “Shotgun Free” and “Shotgun Ultimate” may both have a bundle named “Shotgun.app”), the present software detection method may include an extension to the above method to distinguish between the two (or more) software applications when detecting the presence of installed software applications.

Bundles contain resources, such as artwork and sound files, such that the files contained in the bundle can be assessed to distinguish two applications with the same bundle name with very high probability. For instance, the contents of a bundle can be determined by examination of the install file of the application, where said install file can be obtained by downloading it from the iTunes App Store. Using the method described previously to determine the presence of a bundle, one can similarly check for the existence of a subset of the files within the bundle. This will allow for a more definite determination of whether or not a particular application is installed.

### VIII. Examples

### A. iPhone Implementation

The following example is provided merely for the purpose of illustrating one manner in which the present software detection illustrated in FIG. 5 may be implemented.

Versions of the iPhone OS (e.g., iPhone OS 3.1.3), applications created by third-parties (i.e. not created by Apple) are stored in a predictable location. The root folder for all such applications is “/private/var/mobile/Applications.” The contents of this directory might look as follows:

/private/var/mobile/3B4A43E2-D89D-4B98-BB0C-ED66C95D56AA/
/private/var/mobile/216C2603-1C5F-4EAC-84F0-9C2EEB5A45F4/
/private/var/mobile/4F6E7ACE-1EF2-4417-8BC6-0EF1FB3AF865/

Where each of the “Application” subfolders following “/private/var/mobile/” has a random or semi-random name designed to obscure what application resides within. The random or semi-random name associated with these application subfolders are ascertainable from an analysis of the folder structure for the device being analyzed.

The folder structure within each of these application folders, however, is itself predictable. It might look as follows:

```
/private/var/mobile/3B4A43E2-D89D-4B98-BB0C-ED66C95D56AA/
Documents
/private/var/mobile/3B4A43E2-D89D-4B98-BB0C-ED66C95D56AA/
Library
/private/var/mobile/3B4A43E2-D89D-4B98-BB0C-
  ED66C95D56AA/BundleName.app
/private/var/mobile/3B4A43E2-D89D-4B98-BB0C-ED66C95D56AA/
tmp
/private/var/mobile/3B4A43E2-D89D-4B98-BB0C-
  ED66C95D56AA/iTunesMetadata.plist
/private/var/mobile/3B4A43E2-D89D-4B98-BB0C-ED66C95D56AA/
iTunesArtwork
```

The names of these files and folders are all constant from application to application except for the BundleName.app folder. The “bundle name” for a particular software application is a developer-specified name that will always be the same for any particular version of a particular application. For instance, the software application “Shotgun Free” for the iPhone has the bundle name “Shotgun” and the software application “POW” for the iPhone has the bundle name “POW.” This folder is called the “bundle”.

For each software application installed on a given device, there exists a file that is commonly named for each bundle, as may be specified by the developer of the operating system for each device. For example, in one or more aspects of the disclosure, within the bundle folder for an iPhone OS, there is a file called Info.plist. So in the case of the software application “Shotgun Free” appearing inside of “/private/var/mobile/3B4A43E2-D89D-4B98-BBOC-ED66C95D56AA/”, a file exists with the path:

/private/var/mobile/3B4A43E2-D89D-4B98-BB0C-
ED66C95D56AA/Shotgun.app/Info.plist

The iPhone OS has a class called NSFileManager that allows clients to look at the file system. In one or more aspects of the disclosure, an application that desired to determine whether a different application was installed may utilize NSFileManager to examine the attributes of a particular file and return an error if the check fails. In the case of determining the presence of Shotgun Free, the following code can be used

NSString *resourcePath = @“/private/var/mobile/3B4A43E2-
D89D-4B98-BB0C-
ED66C95D56AA/Shotgun.app/Info.plist”
NSError *err = nil;
[[NSFileManager defaultManager] attributesOfItemAtPath:
resourcePath error:&err];

Regardless of whether or not the software application “Shotgun Free” being searched is installed on the device, the above line is expected to fail upon execution if the “Shotgun Free” application is being searched for by another software application on the device, and “err” will contain an error code. The line is expected to fail either because it is impossible because the software is not there or because a sandbox protection is activated. The error code can then be analyzed to assess whether the software application is installed on the device. There are two relevant outcomes:
1) The error code signifies that the file does not exist. This implies that Shotgun Free is not present within this folder.
2) The error code signifies that we do not have permission to read the file. This implies that Shotgun Free is present within this folder. Permission may not be granted due to security measures on the device intended to “sandbox” software applications that are installed by limiting their knowledge and access to the device's contents.
   Thus, the error code provides a mechanism that can be used to distinguish between these two outcomes, enabling the apparatuses, systems and methods to distinguish between the two cases of “actually not there” vs. “hidden”. Thus, although the list of obfuscated directories is exposed, the contents remain hidden. Nonetheless, the apparatuses, systems and methods can determine whether an application is installed and resident on the device.

These two outcomes are typically mutually exclusive, i.e. if Shotgun Free is present case 2 will always occur, and if Shotgun Free is not present case 1 will always occur.

By performing this check on every folder within “/private/var/mobile,” it can be determined whether or not the user has any application with that bundle name.

By performing this check on every folder within “/private/var/mobile” with every bundle name in a (potentially very large) list of known bundle names, it can be determined whether or not the user has any of the known applications. Further optimizations (weighting popular bundle names, prioritizing folders) are possible for performance but not necessary to demonstrate the nature of the method.

Changes to the operating system may alter the input code and/or the behavior of these error codes or the particular output codes generated, but this example is merely intended to be illustrative of one possible method to indirectly infer the presence of an application. NSFileManager in particular has several operations, such as inspecting, moving, copying, navigating between, and modifying files or folders which all show anomalous behavior that can be used to provide evidence of the existence of a target app.

### B. Brand Loyalty Determination

Using the processes described in FIGS. 5 and 7, an app developer or advertiser could use an installed app containing this feature to identify other apps for which it was also a developer or which relate to its advertised goods in order to assess brand loyalty. As discussed above, assessment of the existence of other apps by the same developer could be made without any change to the other app. As will be appreciated by those skilled in the art, the information obtained using the processes described in FIGS. 5 and 7 can be pushed to a third party, e.g., a developer.

### C. Lifetime Assessment

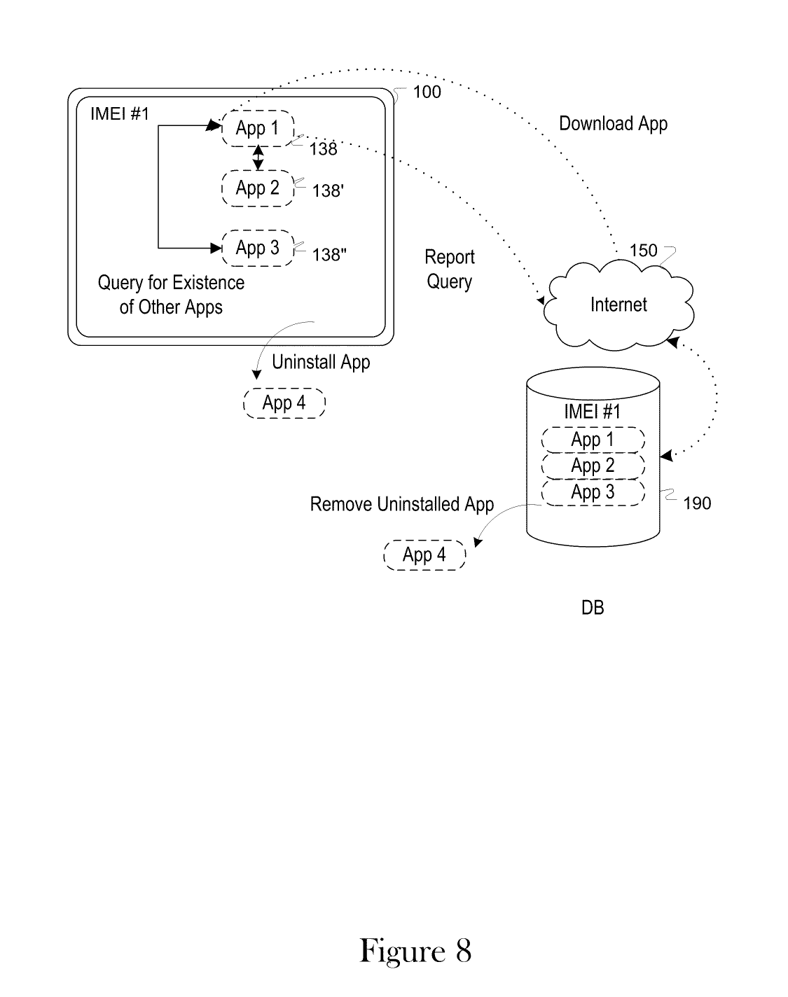

Using the processes described in FIGS. 5 and 7, an assessment could be made by comparing information from a first time and a second time of how long an app was installed on a device before being deleted. Using present methods, an app that has not been launched recently is indistinguishable from an app which has been deleted from the device. In contrast, by using the process described herein a developer or other interested party could make that distinction. This provides the benefits both of a more accurate database of installed apps and of an assessment of the lifetime of the app on the device, which assessment can be useful for business and marketing decisions. To implement this feature, a database of users and their installed applications would need to be maintained as shown in FIG. 8. Any app on the device which has the analytics package included can use the technique to test whether the user still has each of the applications in the database. In response to any app located on a device reporting back a list of apps which omits a previously identified app, the missing app from the real-time evaluation report is then removed from the database of current apps.

### D. Identification of Currently Installed Apps

Using the processes described in FIGS. 5 and 7, an app could be developed that provides a user with a list of currently installed apps on their device. While several apps exist currently to facilitate sharing lists of installed apps through social media like Facebook and Twitter, and that also allow users to review apps they have installed, recommend new apps, etc. They are all limited by the drawbacks of alternative methods outlined in the provisional. The simplest implementation of this is to repeat FIG. 5 over an exhaustive list of apps.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method comprising:
determining identification of software installed on a device using one or more of information about the file system structure, and operation wherein the step of determining the identification of software is performed real-time.

2. The method of claim 1, further comprising testing repeatedly against a known database of possible software applications to construct a user profile of installed software applications on the user's device.

3. The method of claim 1, further comprising determining whether certain software is installed on the device without requiring the detected software to be complicit in the detection.

4. The method of claim 1, further comprising determining whether certain software is installed on the device without requiring user intervention.

5. The method of claim 1, further comprising utilizing the software installation determinations for advertising purposes or other installation metrics.

6. A system comprising:
a device;
a device processor configured to
obtain a list of directories from the device;
attempt an operation on an installed software application bundle within a directory on the device; and
determine if a software application is present on the device.

7. The system according to claim 6 wherein the list of directories is obfuscated.

8. The system according to claim 6 wherein the device processor is further configured to develop a user profile from the list of directories obtained from the device.

9. A system according to claim 6 wherein the installed software application is a target software application.

10. The system of claim 6 wherein the device processor attempts the operation on another software application bundle within another directory on the device.

11. The system of claim 6 wherein the device processor is configured to develop a list of software applications on the device.

12. The system of claim 6 wherein the device processor is further configured to:
instruct the device in a first instruction if a target software application is installed; and
instruct the device in a second instruction if a target software application is not installed.

13. The system of claim 12 wherein the first instruction is an instruction to deliver an advertisement and the second instruction is an instruction not to deliver an advertisement.

14. The system of claim 12 wherein the first instruction is an instruction not to deliver an advertisement and the second instruction is an instruction to deliver an advertisement.

15. The system of claim 6 wherein the device processor is further configured to receive an advertisement over a network.

16. The system of claim 15 wherein the device processor is further configured to deliver the advertisement after determining if the software application is present.

17. The system of claim 6 wherein a targeting fee can be calculated and charged.

18. The system of claim 17 wherein the targeting fee can be charged to an advertiser after receiving and delivering an advertisement over a network.

19. A device comprising:
a housing;
a user interface;
a device processor configured to
obtain a list of directories;
attempt operation on an installed software application bundle within a directory; and
identify if a software application is present on the device.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A method comprising:
obtaining a list of directories;
attempting an operation on an installed software application bundle within a directory from the list of directories; and
identifying a presence or absence of a software application on the device.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A computer program product for delivering to a device, the computer program product being embodied in a computer readable storage medium and comprising computer instructions for:
obtaining a list of directories;
attempting an operation on an installed software application bundle within a directory from the list of directories; and
identifying a presence or absence of a software application on the device.

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. A method comprising:
obtaining a list of directories at a first time;
attempting at the first time an operation on an installed software application bundle within a directory from the list of directories; and
identifying at the first time, a presence or absence of a software application on the device;
providing a list of software applications with a unique device identification number identified at the first time;
obtaining a list of directories at a second time different than the first time;
attempting at the second time an operation on an installed software application bundle within a directory from the list of directories; and
identifying at the second time, a presence or absence of a software application on the device;
providing a list of software applications with a unique device identification number identified at the first time; and
comparing the list of software applications identified at the first time with the list of software applications identified at the second time.
